(19) United States
(12) Patent Application Publication
(10) Pub. No.: US 2018/0185859 A1
(43) Pub. Date: Jul. 5, 2018

(54) PAINTING METHOD AND DEVICE FOR SAME

(71) Applicant: HONDA MOTOR CO., LTD., Tokyo (JP)

(72) Inventors: Naoki KISHIMOTO, Hagagun, Tochigi (JP); Osamu YASHIMA, Hagagun, Tochigi (JP); Masashi TAKEBE, Hagagun, Tochigi (JP); Masaaki SHOJI, Hagagun, Tochigi (JP)

(21) Appl. No.: 15/740,441

(22) PCT Filed: Jun. 27, 2016
(86) PCT No.: PCT/JP2016/069047

§ 371 Date: Dec. 28, 2017

(30) Foreign Application Priority Data
Jun. 30, 2015 (JP) 2015-130587

(51) Int. Cl. B05B 3/10; B05B 5/04; B05D 1/02

(52) U.S. Cl. CPC B05B 3/1014; B05D 1/02; B05B 5/04; B05B 3/1057

(57) ABSTRACT

The present invention relates to a painting method and a rotating atomization type painting device. On an inner surface of a bell cup constituting the rotating atomization type painting device are formed a first paint diffusion unit positioned on the inside in the radial direction and a second paint diffusion unit positioned between the first paint diffusion unit and a peripheral edge part. The first paint diffusion unit has a convex shaped curved surface extending toward the center of rotation of the bell cup, whereas the second paint diffusion unit has a concave shaped curved surface extending away from the center of rotation. The diameter of the bell cup is set at 75-150 mm, and the speed of rotation of the bell cup is set at 8000-30000 rpm.

### TECHNICAL FIELD

The present invention relates to a painting method and a device therefor, the painting method of spraying paint onto a workpiece from the periphery of an internal surface of a rotatable bell cup.

### BACKGROUND ART

A rotary atomization-type painting device is widely used as a painting device that paints a body and so forth of an automobile. As is generally known, in the rotary atomization-type painting device, a bell cup that constitutes the rotary atomization-type painting device is rotated with a high voltage being applied thereto, and, in this state, liquid paint (for example, conductive paint) is supplied to the bell cup. The liquid paint is electrified and, as described in Japanese Patent No. 4274894, atomized due to the centrifugal force, and flies out of the periphery of the bell cup as a liquid thread. The flying liquid paint applied to the body by an electrostatic action or the like based on a potential difference. As a result, electrostatic painting is performed.

### SUMMARY OF INVENTION

The rotational speed of the bell cup is set so that the liquid paint can be scattered from the periphery of the bell cup as a liquid thread. A suitable rotational speed varies depending on the required degree of atomization of the liquid paint; for instance, an appropriate rotational speed is about 50000 rpm if the required particle size of the liquid paint is large and about 10000 rpm if the required particle size of the liquid paint is small.

Incidentally, the centrifugal force that the liquid paint experiences becomes greater as the rotational speed of the bell cup becomes higher. If the liquid paint receives a great centrifugal force, the liquid paint spreads in a wide range in the process of reaching the workpiece after flying out of the periphery of the bell cup. That is, the liquid paint adheres also to an area outside an area to be painted, and the thickness of a coating is reduced in the area to which the liquid paint adhered. As a result, it is not easy to form a coating having a desired thickness in a desired area, which makes it difficult to improve application efficiency.

Thus, reducing the rotational speed of the bell cup may be conceived of. However, if the rotational speed is excessively reduced, the centrifugal force that acts on the liquid paint is decreased. As a result, it is not easy to shear the liquid paint and turn it into droplets.

Consequently, particles of the liquid paint become large and it is not easy to control the thickness of a coating.

A main object of the present invention is to provide a painting method that makes it easy to form a coating having a desired thickness in a desired area of a workpiece.

Another object of the present invention is to provide a painting device that carries out the above-described painting method.

According to an embodiment of the present invention, a painting method is provided, the painting method of spraying paint onto a workpiece from a periphery of an internal surface of a rotatable bell cup, wherein, as the bell cup, a bell cup whose diameter is 75 to 150 mm is used, the internal surface of the bell cup having a first paint spreading portion on an inner side in a radial direction of the internal surface as a convex surface rising toward a rotation center of the bell cup and a second paint spreading portion is formed between the first paint spreading portion and the periphery as a concave surface away from the rotation center, and the rotational speed of the bell cup is set at 8000 to 30000 rpm.

Moreover, according to another embodiment of the present invention, a rotary atomization-type painting device is provided, the rotary atomization-type painting device spraying paint onto a workpiece from a periphery of an internal surface of a rotatable bell cup, wherein the internal surface includes: a first paint spreading portion on an inner side in a radial direction of the internal surface as a convex surface rising toward the rotation center of the bell cup; and a second paint spreading portion between the first paint spreading portion and the periphery as a concave surface away from the rotation center, and the diameter of the bell cup is 75 to 150 mm.

It is more preferable that the diameter of the bell cup is 80 to 120 mm. In this case, it is also possible to set the rotational speed of the bell cup at 10000 to 25000 rpm.

As described above, in the present invention, a large-diameter bell cup is used. Therefore, in trying to obtain a droplet having a diameter approximately equal to that of a droplet obtained when a small-diameter bell cup is used, it is possible to reduce the rotational speed of the bell cup. As a result, the centrifugal force acting on liquid paint moving on the internal surface of the bell cup toward the periphery becomes smaller.

Consequently, a force by which the liquid paint flies outward in the direction of the diameter of the bell cup becomes smaller. For this reason, the spreading range of the liquid paint flying out of the bell cup toward the workpiece is narrowed. This makes it easy to apply the liquid paint to a desired area of the workpiece in a concentrated manner.

In addition, since it is possible to make the diameter of a droplet that is observed when it flies out of the bell cup approximately equal to the diameter of a droplet that would be observed if the bell cup had a small diameter, particles of a coating are prevented from becoming large. This makes the coating have a desired thickness easily.

Moreover, it is preferable to make a plurality of lead-out holes of a hub member that leads the paint to the bell cup have the same shape and same dimensions and aligned in a circumferential direction. In this case, on the internal surface of the bell cup, a liquid film in which the liquid paint is regularly dispersed is formed.

According to the present invention, as the bell cup, a large-diameter bell cup having a diameter of 75 to 150 mm is used. As a result, even when the rotational speed of the bell cup is reduced, it is possible to obtain a droplet having a diameter approximately equal to that of a droplet in the case of a small-diameter bell cup. This makes it easy to obtain a coating having a desired thickness.

In addition, with a decrease in the rotational speed of the bell cup, a force by which the liquid paint flies outward in the direction of the diameter of the bell cup becomes smaller. As a result, the spreading range of the liquid paint flying toward the workpiece is narrowed. This makes it easy to apply the liquid paint to a desired area of the workpiece in a concentrated manner. That is, application efficiency is improved.

For the above-described reasons, it is possible to form a coating having a desired thickness efficiently in a desired area of the workpiece.

### BRIEF DESCRIPTION OF DRAWINGS

FIG. 1 is a side cross-sectional view of a rotary atomization-type painting device according to an embodiment of the present invention in a longitudinal direction thereof;

FIG. 2 is an overall schematic perspective view of a hub member that constitutes the rotary atomization-type painting device of FIG. 1;

FIG. 3 is a cross-sectional view of a principal portion of a bell cup, which constitutes the rotary atomization-type painting device of FIG. 1, in a thickness direction thereof;

FIG. 4 is a schematic diagram depicting a direction in which liquid paint flies;

FIG. 5 is a graph showing the changes in the film thickness of the liquid paint in a revolution direction (phase) on the periphery of the bell cup;

FIG. 6 is a graph showing the calculated values of the diameters of droplets that are observed when the amount of discharged liquid paint is varied;

FIG. 7 is a graph showing the diameters (measured values) of droplets of a first liquid paint which are observed when a bell cup whose diameter is 120 mm or 70 mm is rotated at various rotational speeds;

FIG. 8 is a graph showing the diameters (measured values) of droplets of a second liquid paint which are observed when the bell cup whose diameter is 120 mm or 70 mm is rotated at various rotational speeds;

FIG. 9 is a graph showing the diameters (measured values) of a droplet of a third liquid paint which are observed when the bell cup whose diameter is 120 mm or 70 mm is rotated at various rotational speeds;

FIG. 10 is a graph showing the application efficiency of the first liquid paint which is observed when the bell cup whose diameter is 120 mm or 70 mm is used and the amount of shaping air jet is varied;

FIG. 11 is a graph showing the application efficiency of the second liquid paint which is observed when the bell cup whose diameter is 120 mm or 70 mm is used and the amount of shaping air jet is varied; and

FIG. 12 is a graph showing the application efficiency of the third liquid paint that is observed when the bell cup whose diameter is 120 mm or 70 mm is used and the amount of shaping air jet is varied.

### DESCRIPTION OF EMBODIMENTS

Hereinafter, regarding a painting method according to the present invention, a preferred embodiment thereof will be described in detail with reference to the attached drawings in connection with a rotary atomization-type painting device for carrying out the printing method.

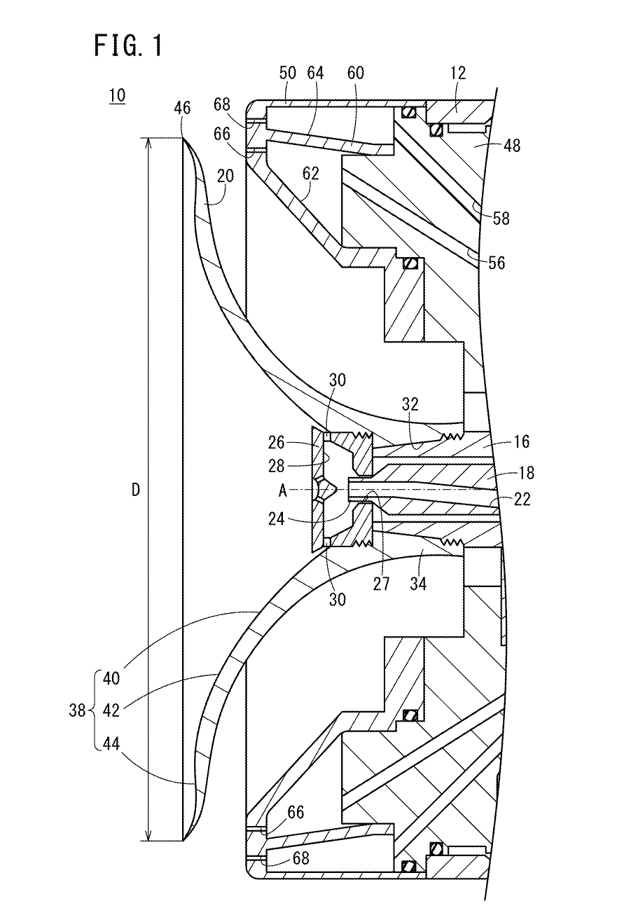

FIG. 1 is a side cross-sectional view of a rotary atomization-type painting device 10 according to the present embodiment in a longitudinal direction thereof. This rotary atomization-type painting device 10 is provided at the tip of an arm that constitutes a painting robot (both of which are not depicted in the drawing).

The rotary atomization-type painting device 10 includes an unillustrated air motor provided in a casing 12, a shaft 16 that is rotated at high speed by the air motor, a tube member 18 for letting liquid paint flow therethrough, and a bell-shaped bell cup 20 coupled to the tip of the shaft 16 by threaded engagement between screw portions. To the air motor, compressed air is supplied from an unillustrated compressed air source. As a result of this supply, the shaft 16 rotates at high speed.

The shaft 16 is electrically connected to an unillustrated high-voltage generating device that generates a high voltage. Therefore, to the bell cup 20, a negative high voltage is applied via the shaft 16.

The shaft 16 is configured as a hollow body, and the tube member 18 is inserted thereinto. The shaft 16 and the tube member 18 are separated from each other; therefore, a clearance of predetermined spacing is formed between the members 16 and 18.

Moreover, in the tube member 18, a paint supply channel 22 is formed for letting paint flow therethrough.

Furthermore, at a tip portion of the tube member 18, a paint supply nozzle 24 that discharges the paint is provided. It is to be noted that, in the tube member 18, a cleaning liquid supply channel (not depicted in the drawing) is also formed for letting a cleaning liquid flow therethrough.

To the bell cup 20, a hub member 26 is attached. In the hub member 26, a paint reservoir portion 28, which is a space for temporarily storing the liquid paint supplied via the tube member 18 is formed. The tip of the paint supply nozzle 24 is passed through an insertion hole 27 of the hub member 26 and faces a central part of the paint reservoir portion 28. It is to be noted that the inner peripheral wall of the insertion hole 27 and the paint supply nozzle 24 are separated from each other; therefore, a clearance of predetermined spacing is formed between the hub member 26 and the paint supply nozzle 24.

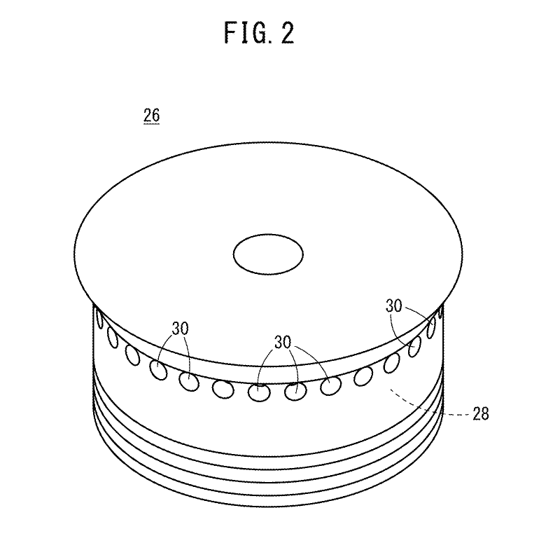

As depicted in FIG. 2, in the hub member 26, a plurality of discharge holes 30 (lead-out holes) are formed for discharging the liquid paint stored in the paint reservoir portion 28. The discharge holes 30 have the same shape and same dimensions, and the adjacent discharge holes 30 and 30 are separated from each other at regular intervals. That is, in the hub member 26, a large number of discharge holes 30 are formed so as to be separated from each other at regular intervals around the hub member 26 on the side wall thereof.

Back in FIG. 1, the bell cup 20 has a cylindrical portion 34 in which an insertion hole 32 is formed. The tip of the shaft 16 is inserted into the insertion hole 32. Moreover, the hub member 26 is held on an internal surface 38 of the bell cup 20 by threaded engagement between screw portions (by screwing). Therefore, when the shaft 16 rotates by the action of the air motor, the bell cup 20 and the hub member 26 also follow the rotation thereof and rotate in an integrated manner.

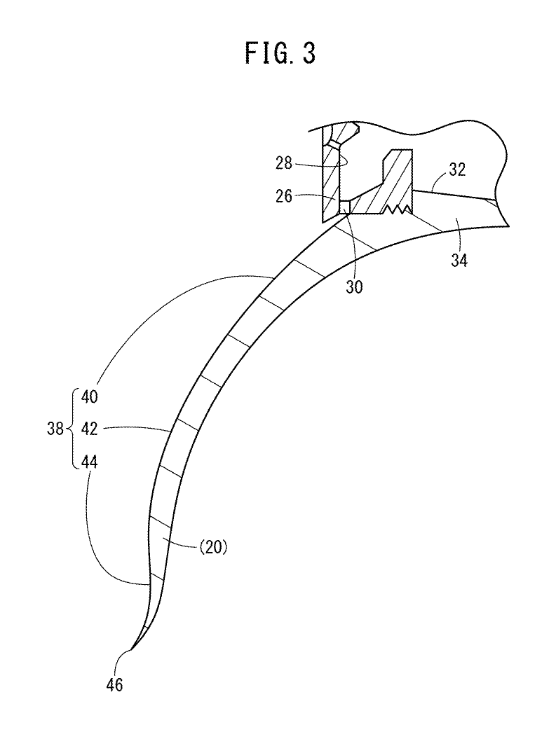

Here, a cross-sectional view of the bell cup 20 in a thickness direction thereof is depicted in FIG. 3. It is to be noted that the thickness direction of the bell cup 20 agrees with the longitudinal direction of the rotary atomization-type painting device 10.

The internal surface 38 of the bell cup 20 is a paint spreading surface on which the liquid paint discharged from the discharge holes 30 of the hub member 26 spreads by the centrifugal force applied from the bell cup 20. The internal surface 38 (the paint spreading surface) is configured with a tapered portion 40, a first paint spreading portion 42, and a second paint spreading portion 44 which are formed in order from a side close to the hub member 26, that is, the inside in a direction of the diameter.

The tapered portion 40 among them is an area which widens in a tapered shape from the side where the hub member 26 is located toward the periphery. The tapered portion 40 occupies almost half of the length of the internal surface 38 (the distance from an area facing the discharge holes 30 to a periphery 46). It is preferable that an angle which a rotation axis A passing through the rotation center of the hub member 26 and the bell cup 20 forms with the tapered portion 40 is 45° or less.

The first paint spreading portion 42 continuously connected to the tapered portion 40 is formed as a convex surface that slightly rises toward the rotation axis A (see FIG. 1). The first paint spreading portion 42 is, for example, a curved surface having a predetermined radius of curvature.

To the first paint spreading portion 42, the second paint spreading portion 44 is continuously connected. That is, the second paint spreading portion 44 is interposed between the first paint spreading portion 42 and the periphery 46. This second paint spreading portion 44 is formed as a concave surface which is slightly depressed in a direction away from the rotation axis A. The second paint spreading portion 44 is, for example, a curved surface having a predetermined radius of curvature.

Furthermore, in the internal surface 38, near the periphery 46, an unillustrated guide groove continuously connected to the second paint spreading portion 44 is formed.

Here, the diameter D (see FIG. 1) of the bell cup 20 is set at 75 to 150 mm. If the diameter D is less than 75 mm, it is necessary to rotate the bell cup 20 at high speed. On the other hand, if the diameter D exceeds 150 mm, the bell cup 20 becomes too large to be handled. A more suitable range of the diameter D of the bell cup 20 is 80 to 120 mm. The diameter D is defined as a straight line connecting an arbitrary point on the periphery 46 of the bell cup 20 and another point on the periphery 46 separated therefrom 180° by using the rotation axis A as an axis of symmetry.

The rotary atomization-type painting device 10 further includes a flow channel formation member 48 that is housed in the casing 12 and a shaping air ring 50 that produces a jet of shaping air toward the outer edge of the bell cup 20.

In the flow channel formation member 48, air supply channels 56, 58 connected to an unillustrated air supply source are formed. Meanwhile, the inside of the shaping air ring 50 is partitioned into a first chamber 62 and a second chamber 64 by a partition wall 60. Moreover, at the end of the shaping air ring 50 which faces the bell cup 20, a plurality of inner jet holes 66 and outer jet holes 68 are formed so as to circle around the periphery 46 of the bell cup 20. The above-described air supply channels 56, 58 communicate with the inner jet holes 66 and the outer jet holes 68 via the first chamber 62 and the second chamber 64, respectively. Therefore, the shaping air is sprayed from each of the inner jet holes 66 and the outer jet holes 68.

The rotary atomization-type painting device 10 according to the present embodiment is basically configured as described above; the operation and effect thereof will next be described.

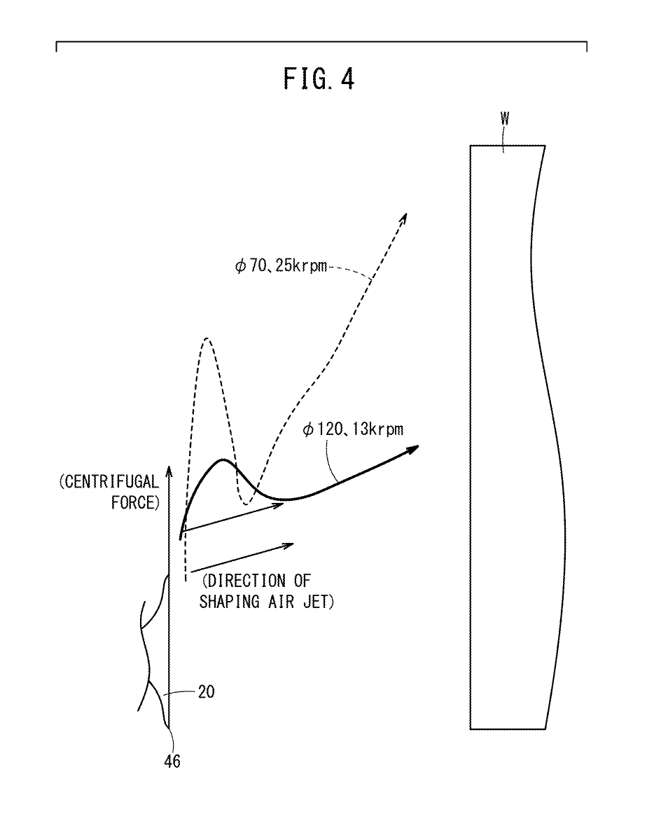

When a workpiece W depicted in FIG. 4 is painted, the above-described robot performs an appropriate operation and makes the rotary atomization-type painting device 10 face the workpiece W. Next, the shaft 16, the hub member 26, and the bell cup 20 are rotated by the action of the above-described air motor and a negative high voltage is applied to the bell cup 20 by the above-described high-voltage generating device.

Furthermore, liquid paint is discharged from the paint supply nozzle 24 toward the paint reservoir portion 28 of the hub member 26. The liquid paint flows out of the discharge holes 30 of the hub member 26 onto the internal surface 38 of the bell cup 20 and turns into a liquid film thinned by the centrifugal force from the rotating bell cup 20, and moves toward the periphery 46 of the bell cup 20 in this state.

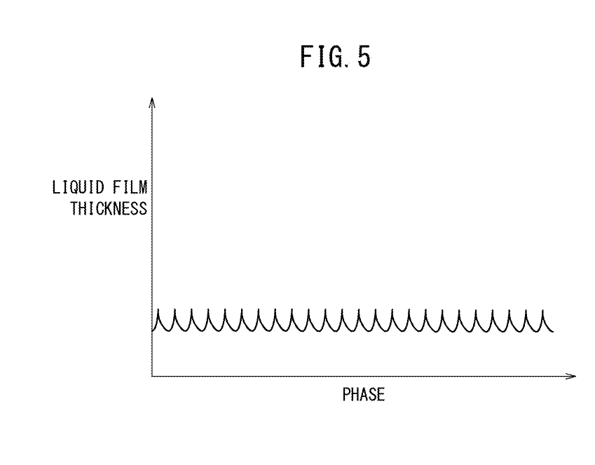

Here, in the present embodiment, it is assumed that all the discharge holes 30 have the same shape and same dimensions and are separated from each other at regular intervals. In this case, the liquid paint is substantially evenly discharged from the discharge holes 30. As a result, the liquid paint is regularly scattered on the internal surface 38 of the bell cup 20. Thus, on the periphery 46 of the bell cup 20, as depicted in FIG. 5, the thickness of the liquid film can be approximately equal and small. It is to be noted that FIG. 5 depicts the changes in the thickness of the liquid film in the circumferential direction on the periphery 46, in other words, along the phase.

In addition, in the internal surface 38 of the bell cup 20, the first paint spreading portion 42 and the second paint spreading portion 44 are formed (see FIG. 3). Since the first paint spreading portion 42 is a convex surface, a component of the centrifugal force acting on the liquid paint passing through the first paint spreading portion 42 becomes greater. This increases the moving speed of the liquid paint and contributes to the attainment of a thinner film of liquid paint.

Moreover, since the second paint spreading portion 44 is a concave surface, when the liquid paint passes through the second paint spreading portion 44, of the component of the centrifugal force, a component of force in a direction perpendicular to the concave surface becomes greater. As a result, the liquid paint is easily led to the periphery 46. Since the negative high voltage is applied to the bell cup 20, most of the liquid paint is electrified in the process of moving on the internal surface 38 of the bell cup 20 after being discharged from the discharge holes 30 of the hub member 26. It is to be noted that part of the liquid paint is electrified before being discharged from the discharge holes 30.

Meanwhile, shaping air is supplied from the above-described air supply source. A part of the shaping air is sprayed from the inner jet holes 66 via the air supply channel 56 of the flow channel formation member 48 and the first chamber 62 of the shaping air ring 50, and another part of the shaping air is sprayed from the outer jet holes 68 via the air supply channel 58 of the flow channel formation member 48 and the second chamber 64 of the shaping air ring 50. The shaping air jet from the inner jet holes 66 makes the liquid paint fly out of the periphery 46 of the bell cup 20 as a liquid thread as depicted in FIG. 4.

Moreover, since the shaping air jet from the outer jet holes 68 becomes an air curtain, the spreading range of the liquid thread is defined.

The liquid thread released from the bell cup 20 flies toward the workpiece W. This workpiece is electrically connected to the ground or the like, in advance. As a result, there is a potential difference between the liquid paint and the workpiece. Therefore, the liquid paint is attracted to the workpiece by electrostatic action and adheres to the workpiece.

Here, a bell cup 20 having a diameter D of 70 mm and a bell cup 20 having a diameter D of 120 mm are used to determine the rotational speed at which droplets released therefrom have the same size.

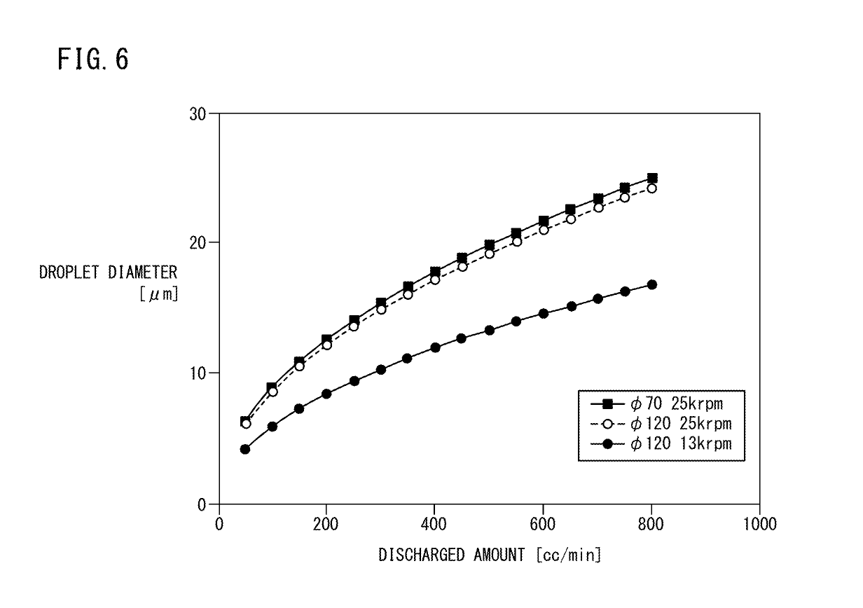

The diameter of a droplet shortly after the droplet flew out of the periphery 46 of the bell cup 20 as a liquid thread varies in accordance with rotational speed, diameter, or the like of the bell cup 20. This point will be described with reference to FIGS. 6 to 9.

FIG. 6 is a graph showing the diameters of a droplet which are observed when the amount of discharge of the liquid paint is varied. As is clear from FIG. 6, when the bell cup 20 whose diameter is 120 mm is used, at the rotational speed of 13 k (13000) rpm, a droplet released therefrom has an approximately equal diameter to that released from the bell cup 20 whose diameter is 70 mm and rotational speed is set at 25 k (25000) rpm. That is, when the 120-mm bell cup 20 is used, rotational speed can be set to be almost half of the rotational speed which is set when the 70-mm bell cup 20 is used.

In FIG. 6, the changes in the diameter of a droplet which are observed when the bell cup 20 whose diameter is 120 mm is used and the rotational speed is set to be the same as the rotational speed of the bell cup 20 whose diameter is 70 mm are also shown. At the same rotational speed, the diameter of a droplet is decreased with an increase in the diameter of the bell cup 20. This is because, in this case, the centrifugal force acting on the liquid paint becomes greater and the liquid paint is sheared.

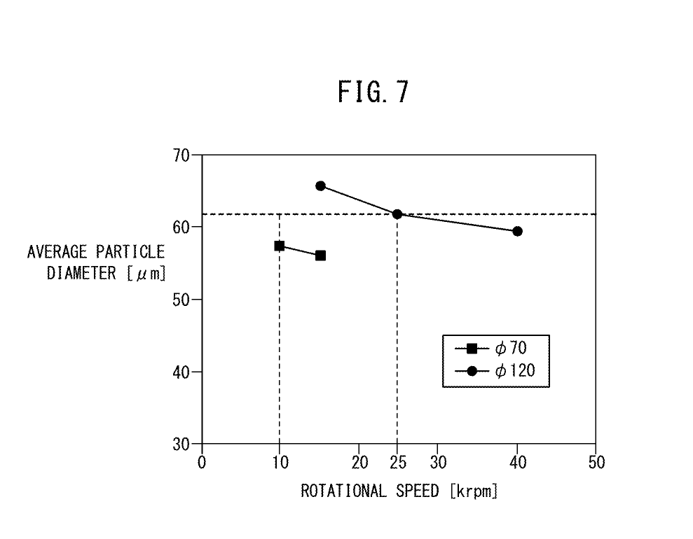

Furthermore, FIGS. 7 to 9 are graphs showing the changes in the diameters (measured values) of droplets of first to third liquid paints having different viscosities. The droplets are observed when a bell cup 20 whose diameter is 120 mm or 70 mm is used and rotational speed is varied.

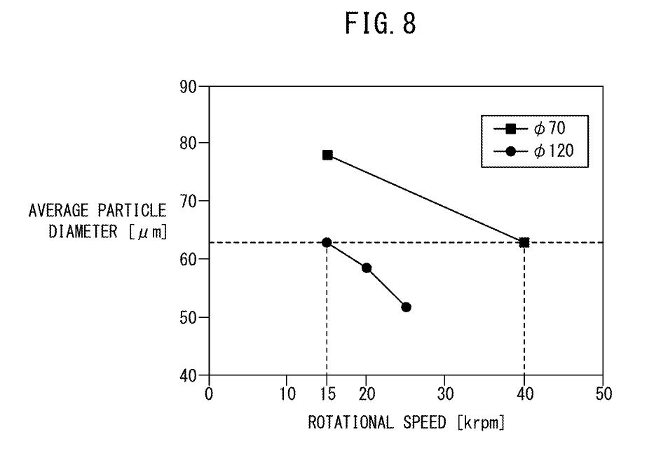

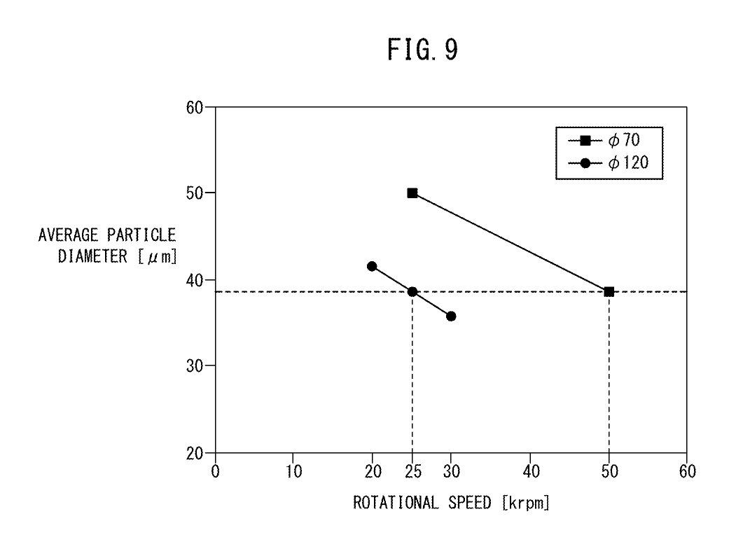

The viscosities of the first to third liquid paints are increased in the order of FIG. 7, FIG. 8, and FIG. 9. It is clear from these FIGS. 7 to 9 that, using the bell cup 20 whose diameter is 120 mm, rotational speed can be reduced by half to have the same size of the droplets as that in the case of the bell cup 20 having a diameter of 70 mm.

From the above results, it is clear that, when approximately equal diameters of droplets are obtained, by adopting the bell cup 20 having a larger diameter D, the rotational speed of the bell cup 20 can be reduced.

In FIG. 4, a dashed line indicates a flight path of the liquid paint which is observed when the bell cup 20 whose diameter is 70 mm is used and rotational speed is set at 25 krpm, and a solid line indicates a flight path of the liquid paint which is observed when the bell cup 20 whose diameter is 120 mm is used and rotational speed is set at 13 krpm. It is clear from this FIG. 4 that, in the latter case, it is possible to narrow the spreading range of the liquid paint while making the diameter of a droplet approximately equal to the diameter of a droplet in the former case. This is because, in the latter case, the centrifugal force acting on the liquid paint becomes smaller due to low rotational speed; accordingly a force by which the liquid paint flies outward in the direction of the diameter of the bell cup 20 becomes smaller.

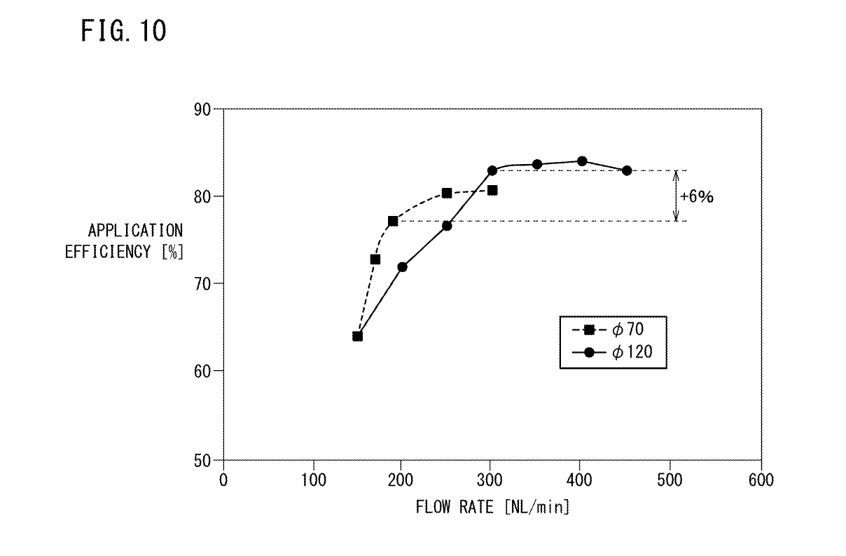

FIGS. 10 to 12 are graphs showing the changes in application efficiency which are observed when the first to third liquid paints shown in FIGS. 7 to 9 are respectively used and the amount of shaping air jet is varied. It is to be noted that application efficiency comparison is performed under the condition that the same painting width is obtained. That is, the application efficiency is observed when, assuming that the width of half the maximum thickness of a coating is a pattern width, the pattern width becomes 300 mm.

In FIG. 10, application efficiency which is observed when shaping air is sprayed at a rate of 200 NL/min in the case of the diameter of 70 mm is compared with application efficiency which is observed when shaping air is sprayed at a rate of 300 NL/min in the case of the diameter of 120 mm.

In this case, it has been confirmed that application efficiency has been improved by 6%.

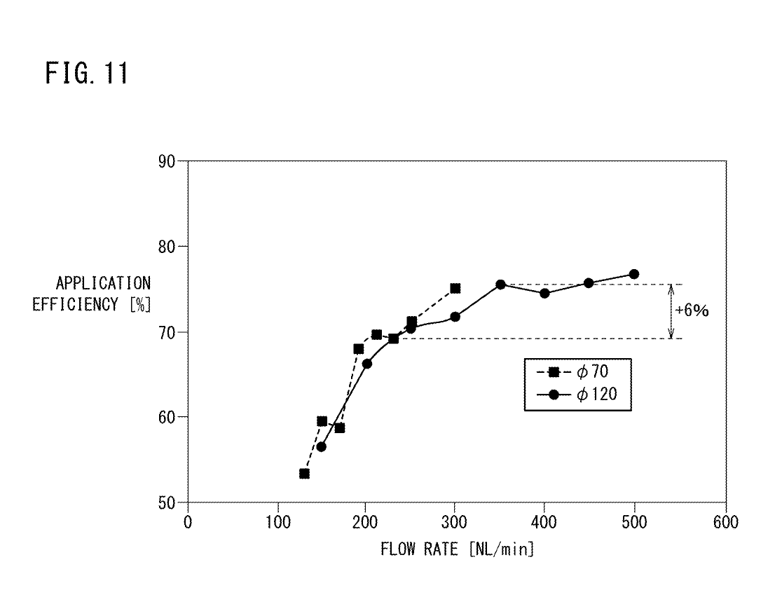

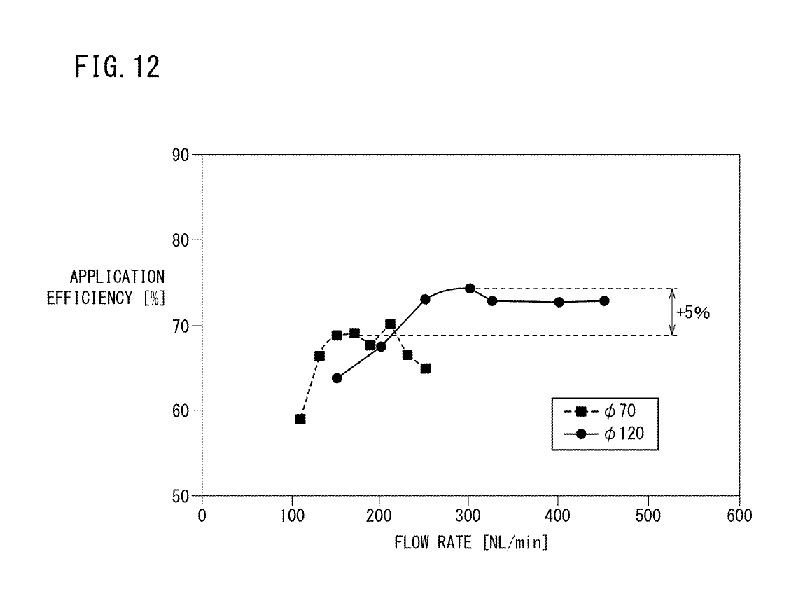

Moreover, FIG. 11 shows application efficiency which is observed when shaping air is sprayed at a rate of 225 NL/min in the case of the diameter of 70 mm and application efficiency which is observed when shaping air is sprayed at a rate of 350 NL/min in the case of the diameter of 120 mm. In addition, FIG. 12 indicates application efficiency which is observed when the shaping air is sprayed at a rate of 150 NL/min in the case of the diameter of 70 mm and application efficiency which is observed when the shaping air is sprayed at a rate of 300 NL/min when the diameter of 120 mm. It has been confirmed that application efficiencies have been improved by 6% and 5%, respectively.

As described above, according to the present embodiment, by using the bell cup 20 with a large diameter D, it is possible to obtain a desired diameter of a droplet while reducing the rotational speed of the bell cup 20 and narrow the range in which the liquid paint spreads when it flies out. This makes it possible to concentrate paint with a desired particle diameter onto a desired area of the workpiece W and improve application efficiency. As a result, it is possible to form a coating having a desired thickness.

The present invention is not limited to the above-described embodiment and can be changed in various ways within the scope of the present invention.

For example, it is not particularly necessary to form the guide groove near the periphery 46 of the bell cup 20.

1. A painting method of spraying paint onto a workpiece from a periphery of an internal surface of a rotatable bell cup, wherein
as the bell cup, a bell cup whose diameter is 75 to 150 mm is used, the internal surface of the bell cup includes a first paint spreading portion on an inner side in a radial direction of the internal surface as a convex surface rising toward a rotation center of the bell cup; and a second paint spreading portion between the first paint spreading portion and the periphery as a concave surface away from the rotation center, and
rotational speed of the bell cup is set at 8000 to 30000 rpm.

2. The painting method according to claim 1, wherein the bell cup has a diameter of 80 to 120 mm is used at a rotational speed of the bell cup is set at 10000 to 25000 rpm.

3. A rotary atomization-type painting device that sprays paint onto a workpiece from a periphery of an internal surface of a rotatable bell cup, wherein
the internal surface of the bell cup includes: a first paint spreading portion on an inner side in a radial direction of the internal surface as a convex surface rising toward a rotation center of the bell cup, and
a second paint spreading portion between the first paint spreading portion and the periphery as a concave surface away from the rotation center, and
a diameter of the bell cup is 75 to 150 mm.

4. The rotary atomization-type painting device according to claim 3, wherein the diameter of the bell cup is 80 to 120 mm.

5. The rotary atomization-type painting device according to claim 3, wherein a plurality of lead-out holes having same shape and same dimensions are formed in a circumferential direction in a hub member that leads the paint out to the bell cup.
